(19) United States
(12) Patent Application Publication
(10) Pub. No.: US 2025/0292637 A1
(43) Pub. Date: Sep. 18, 2025

(54) System, method, and device for converting digital data from a controller area network chip to analog signals for display on a vehicle gauge

(71) Applicant: Ohio INTX Cooperative, Eastlake, OH (US)

(72) Inventor: William Edward PRICE, Lakeline, OH (US)

(73) Assignee: Ohio INTX Cooperative, Eastlake, OH (US)

(21) Appl. No.: 19/078,806

(22) Filed: Mar. 13, 2025

Related U.S. Application Data
(60) Provisional application No. 63/566,685, filed on Mar. 18, 2024.
(60) Provisional application No. 63/647,178, filed on May 14, 2024.

(51) Int. Cl. G07C 5/08; B60K 35/22; B60R 16/023; G06F 3/14

(52) U.S. Cl. CPC G07C 5/0825; B60R 16/0231; G06F 3/14; B60K 35/22; B60K 2360/167; B60K 2360/586

(57) ABSTRACT

A system for generating a display image on one or more vehicle gauges includes a controller area network (CAN bus) chip, a converter chip, and one or more vehicle gauges. The converter chip includes a plurality of ports and embedded software for converting digital data from the controller area network (CAN bus) chip to analog signals. Each vehicle gauge is electrically connected to at least one port of the plurality of ports. The controller area network (CAN bus) chip is electrically connected via a first plurality for wires to the converter chip. The one or more vehicle gauges includes at least one vehicle gauge selected from the group consisting of a speedometer, a battery power gauge, a battery state of charge gauge, an electric motor temperature gauge, a battery temperature gauge, and a check motor gauge.

### CROSS REFERENCES AND PRIORITIES

This application claims priority from U.S. Provisional Application No. 63/566,685 filed on 18 Mar. 2024 and U.S. Provisional Application No. 63/647,178 filed on 14 May 2024, the teachings of each of which are incorporated by reference herein in their entirety.

### BACKGROUND

For several decades, internal combustion engines have been used in the overwhelming majority of automobiles as a means of providing propulsion. Internal combustion engine vehicles typically include a dashboard comprising several gauges used to provide information about vehicle operation to the vehicle operator. Non-limiting examples of such gauges include a speedometer for measuring speed (typically in miles per hour (MPH), kilometers per hour (KPH), or both), a tachometer for measuring the engines revolutions per minute (RPM), a fuel level gauge, an engine water temperature gauge, an engine oil pressure gauge, and a check engine light.

In recent years, electric motors have become a popular alternative to internal combustion engines as a means for providing propulsion for automobiles. Purpose built electric vehicles are now available from several manufacturers. Additionally, individuals and aftermarket companies have begun modifying existing internal combustion engine vehicles by replacing the internal combustion engine and drivetrain with an electric motor and drivetrain (commonly referred to as an “EV swap”).

One challenge faced by those attempting an EV swap is installing and controlling the vehicle gauges. Electric motors and corresponding drivetrains for electric vehicles typically utilize a unique controller area network (CAN bus) to allow microcontrollers and devices-including drivetrain systems and gauges-in the vehicle to communicate with one another. Typical electric vehicle gauges operate digitally by receiving data directly from the CAN bus network of the vehicle's electric motor and/or drivetrain. However, gauges in older internal combustion engine vehicles are often analog gauges which are incapable of receiving data from an electric motor and/or drivetrain CAN bus network. Additionally, the gauges included in traditional internal combustion engine vehicles often measure parameters such as fuel level, oil pressure, engine water temperature, and engine RPM which are not applicable to electric motor driven vehicles.

Currently, those conducting an EV swap address these issues by simply utilizing a separate system—often in the form of a tablet computer connected to the vehicle's center counsel—for measuring and reporting parameters such as vehicle speed, battery charge percentage, motor temperature, battery power (typically reported in kilowatts (kW)), and battery temperature while leaving the vehicle's existing gauges inoperative. This work around is often inconvenient-forcing the vehicle operator to look towards the center counsel to determine vehicle operating parameters such as their speed of travel instead of looking directly in front of them at the dash. Additionally, these solutions detract from the aesthetic appearance of the vehicle interior by leaving the original gauges inoperative and relying instead on an (often crudely mounted) tablet computer.

The need exists, therefore, for an improved system, method, and/or device for installing and controlling vehicle gauges when conducting an EV swap.

### SUMMARY

Described herein is a system for generating a display image on one or more vehicle gauges. The system includes a controller area network (CAN bus) chip, a converter chip, and one or more vehicle gauges. The converter chip including a plurality of ports and embedded software for converting digital data from the controller area network (CAN bus) chip to analog signals. Each vehicle gauge electrically connects to at least one port of the plurality of ports. The controller area network (CAN bus) chip electrically connects via a first plurality of wires to the converter chip. The one or more vehicle gauges includes at least one vehicle gauge selected from the group consisting of a speedometer, a battery power gauge, a battery state of charge gauge, an electric motor temperature gauge, a battery temperature gauge, and a check motor gauge.

In some embodiments, the one or more vehicle gauges may include at least one pulse driven gauge. In such embodiments, the controller area network (CAN bus) chip may include an oscillator component. The embedded software may be configured to adjust an electric frequency from the oscillator component and send an adjusted frequency to the at least one pulse driven gauge.

In certain embodiments, the one or more vehicle gauges may include at least one resistance driven gauge having a pullup resistor. In such embodiments, the converter chip may include a digital to analog converter component connected to an amplifier. The embedded software may be configured to provide a voltage via the digital to analog converter component and amplifier to the at least one resistance driven gauge with the voltage being sufficient to overwhelm the pullup resistor.

In some embodiments, the one or more vehicle gauges may include at least one resistance driven gauge. In such embodiments, the converter chip may include a ground connected transistor and an analog to digital converter. The embedded software may be configured to switch the ground connected transistor on and off by pulse width modulation to send a current to the at least one resistance driven gauge.

In certain embodiments, the one or more vehicle gauges may include at least one indicator light having a current limiting resistor electrically connected to a 12-volt power source and to ground. In such embodiments, the controller area network (CAN bus) chip may be configured to send a signal through the converter chip to the at least one indicator light.

In some embodiments, the converter chip may further include a capacitor. In certain embodiments, the converter chip may further include a ferrite bead.

### BRIEF DESCRIPTION OF FIGURES

FIG. 1 illustrates an exemplary embodiment of a system for generating a display image on one or more vehicle gauges.

FIG. 2 illustrates an exemplary embodiment of a device for converting digital data from a controller area network (CAN bus) chip to one or more analog signals.

FIG. 3 illustrates an exemplary embodiment of a portion of a wiring schematic for a system for generating a display image on one or more vehicle gauges.

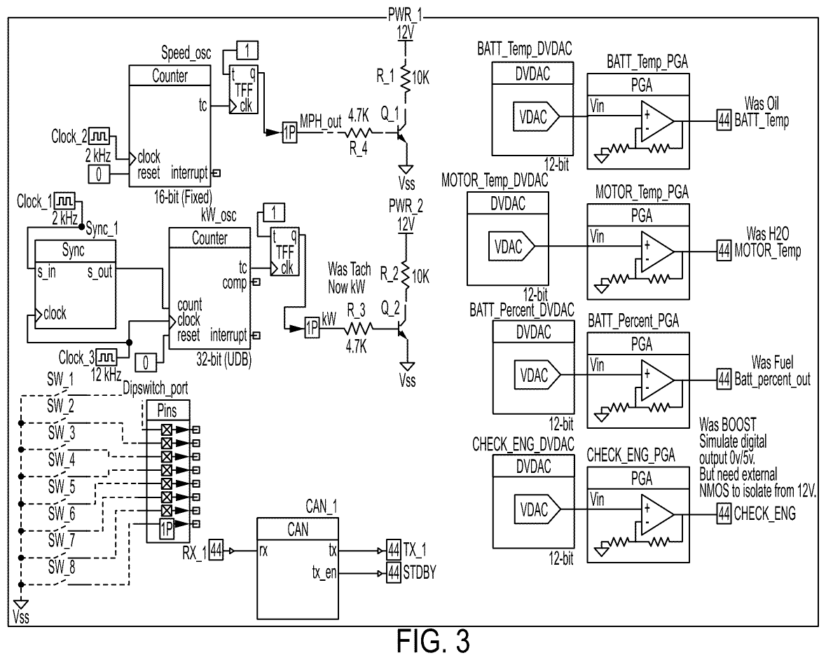

FIG. 4A illustrates an exemplary embodiment of a portion of a wiring schematic for a system for generating a display image on one or more vehicle gauges.

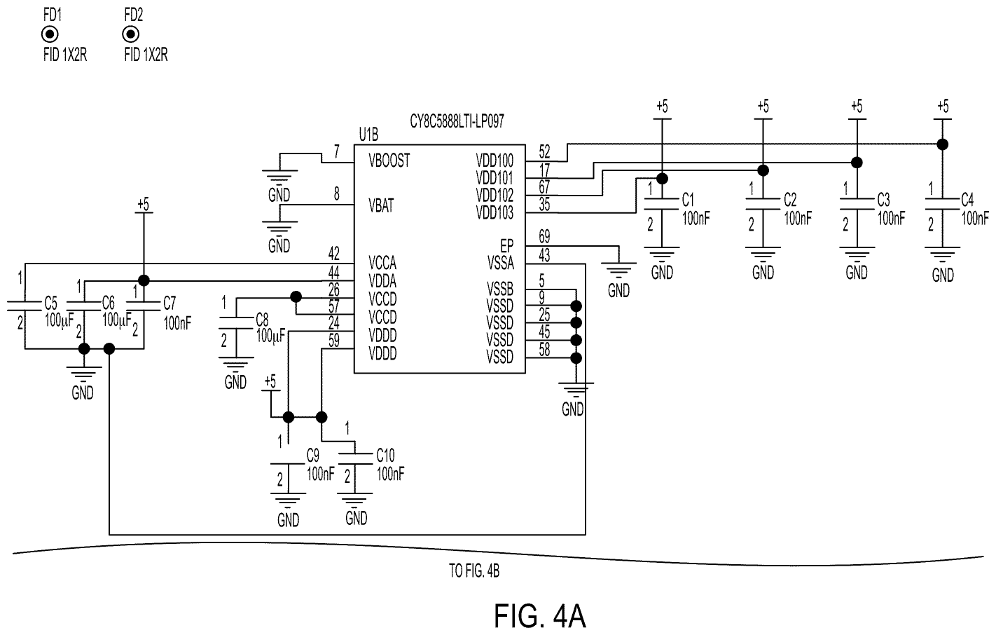

FIG. 4B illustrates an exemplary embodiment of another portion of a wiring schematic for generating a display image on one or more vehicle gauges.

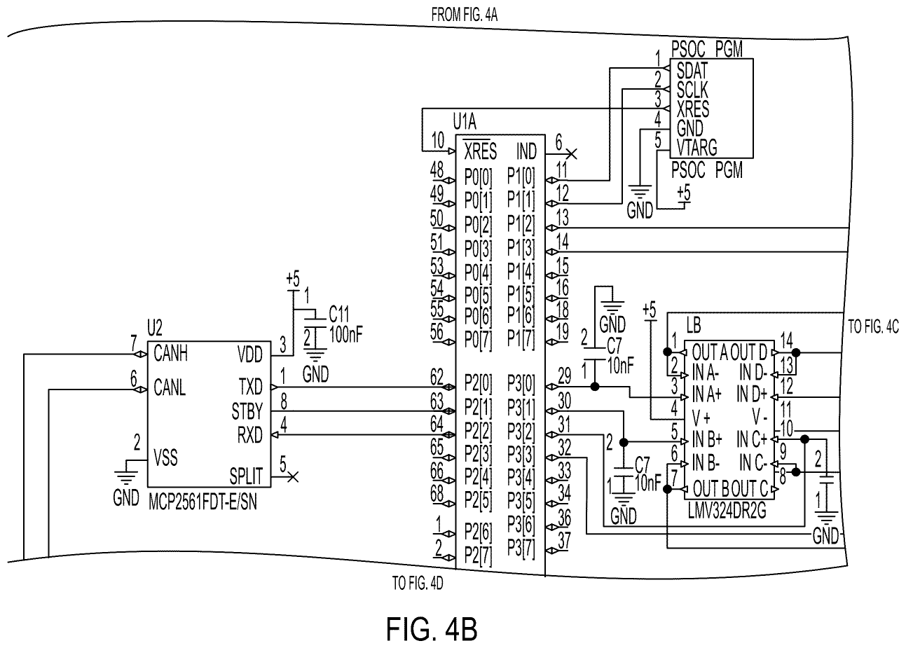

FIG. 4C illustrates an exemplary embodiment of another portion of a wiring schematic for generating a display image on one or more vehicle gauges.

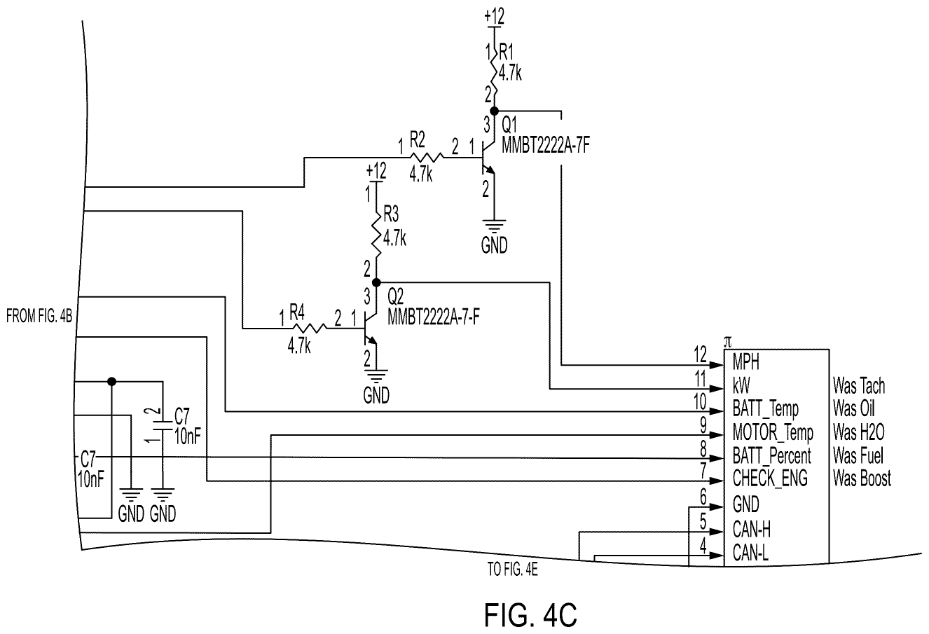

FIG. 4D illustrates an exemplary embodiment of another portion of a wiring schematic for generating a display image on one or more vehicle gauges.

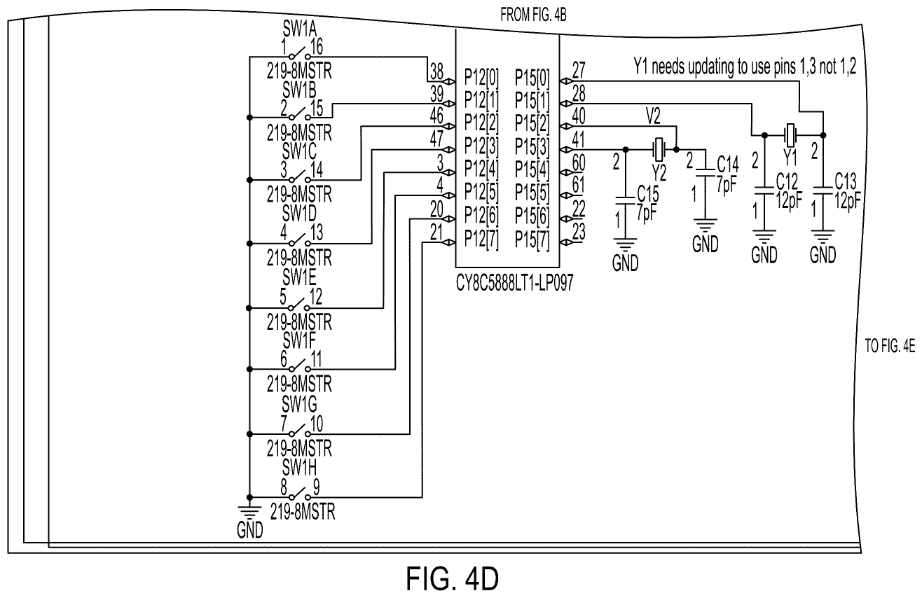

FIG. 4E illustrates an exemplary embodiment of another portion of a wiring schematic for generating a display image on one or more vehicle gauges.

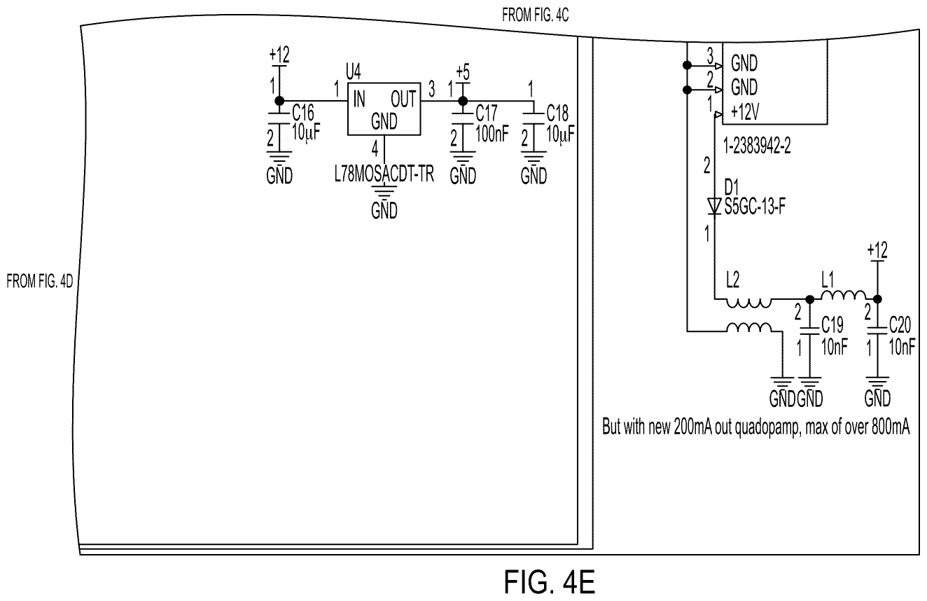

FIG. 5 is an enlarged image of a portion of the exemplary embodiment of FIG. 4.

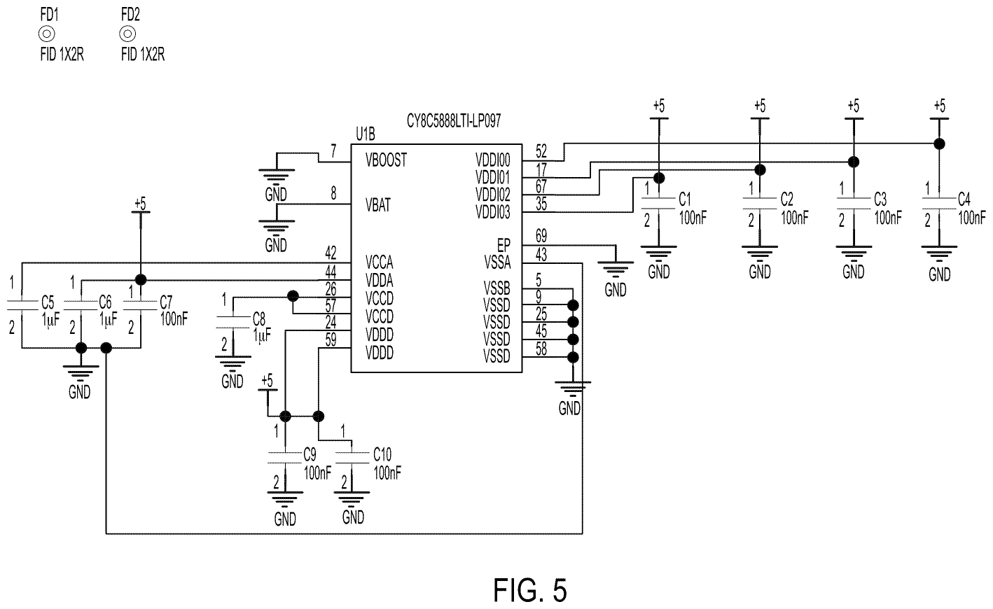

FIG. 6A is an enlarged image of a second portion of the exemplary embodiment of FIG. 4.

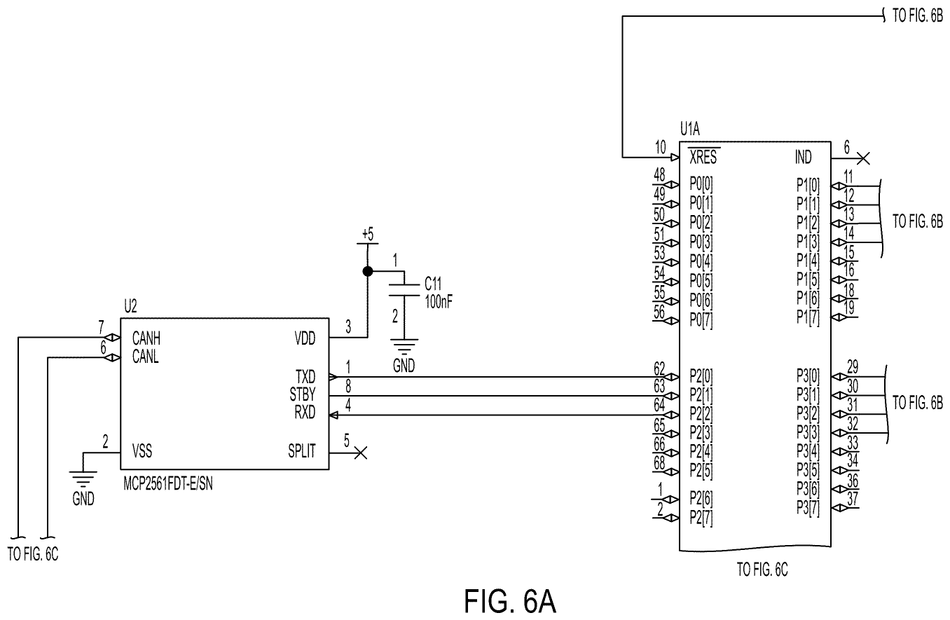

FIG. 6B is an enlarged image of a third portion of the exemplary embodiment of FIG. 4.

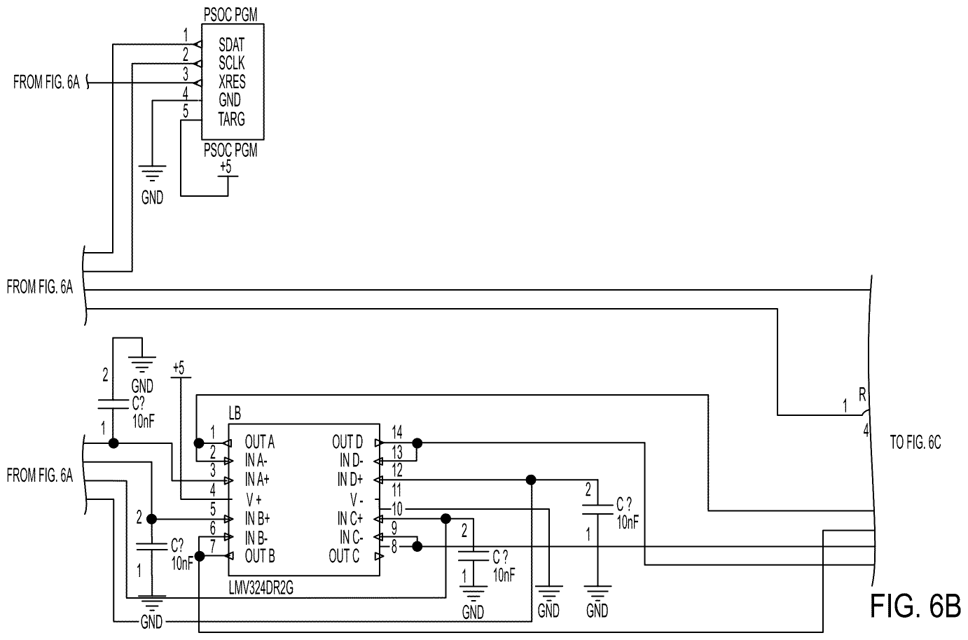

FIG. 6C is an enlarged image of a fourth portion of the exemplary embodiment of FIG. 4.

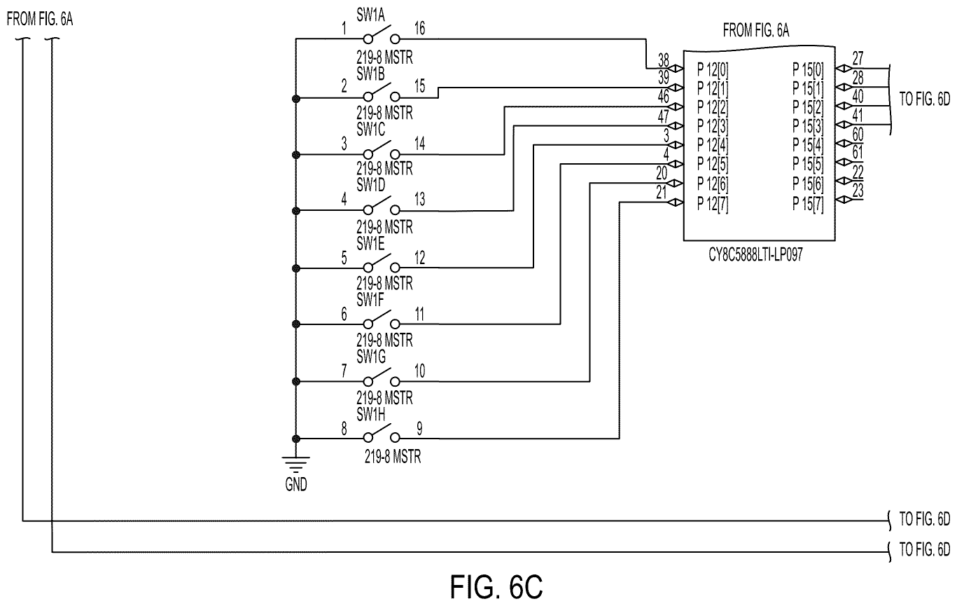

FIG. 6D is an enlarged image of a fifth portion of the exemplary embodiment of FIG. 4.

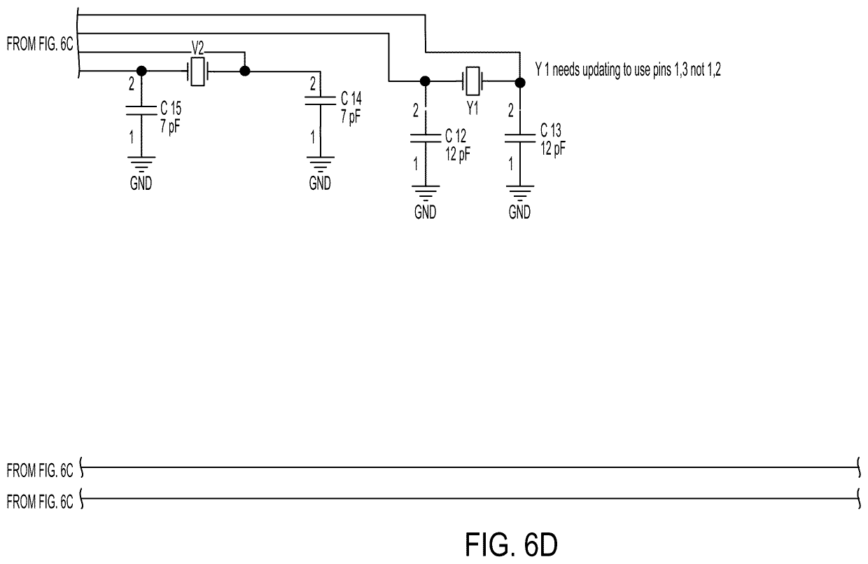

FIG. 7 is an enlarged image of a third portion of the exemplary embodiment of FIG. 4.

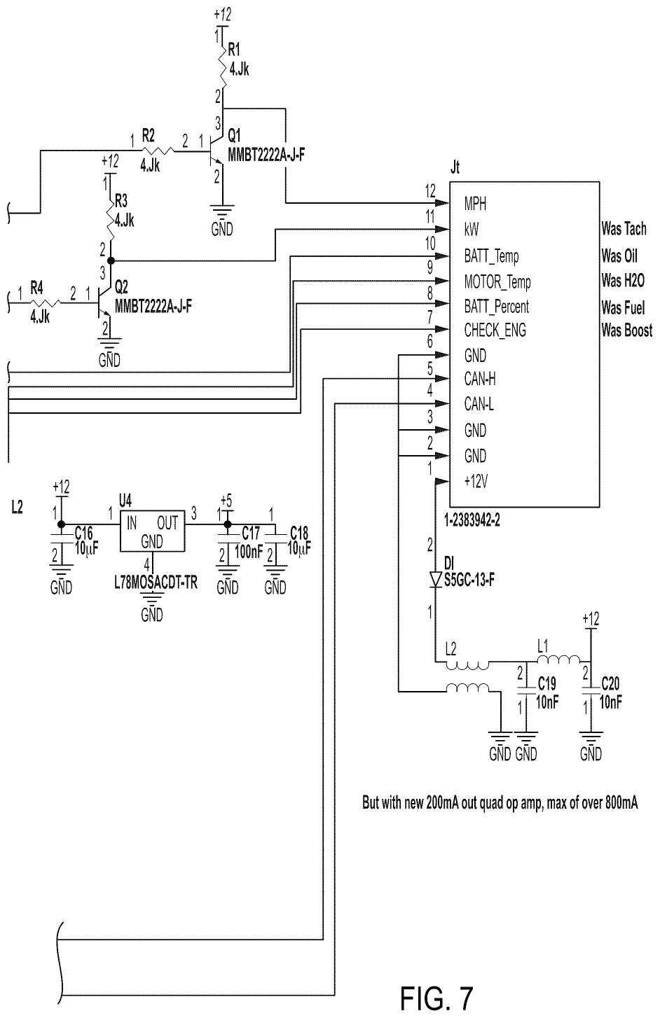

FIG. 8 is an exemplary embodiment of a device for converting digital data from a controller area network (CAN bus) chip to one or more analog signals.

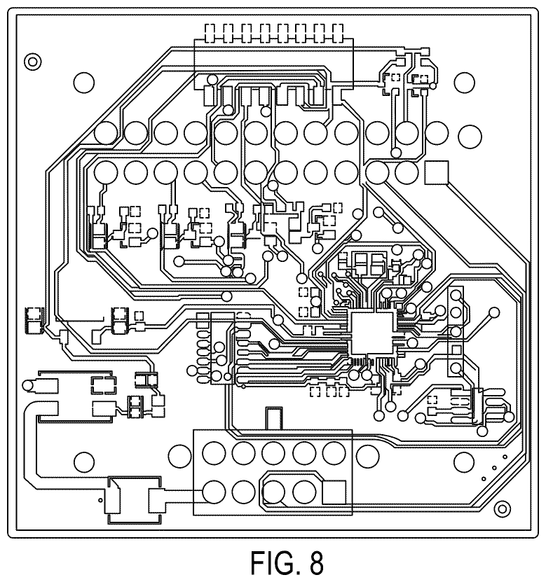

FIG. 9 is an exemplary embodiment of a portion of a wiring schematic for a system for generating a display image on one or move vehicle gauges.

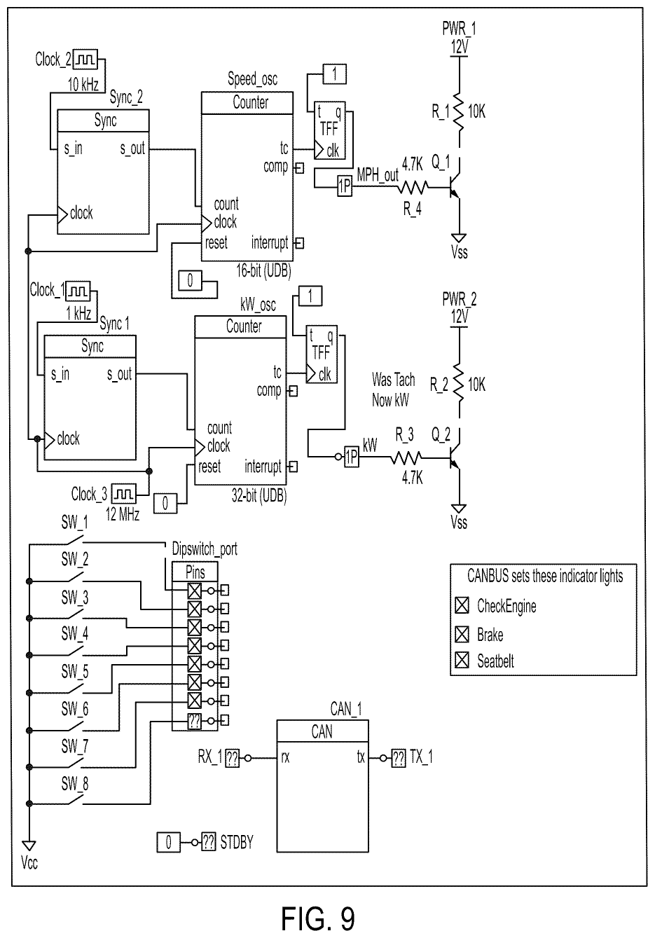

FIG. 10 is an exemplary embodiment of a portion of a wiring schematic for a system for generating a display image on one or move vehicle gauges.

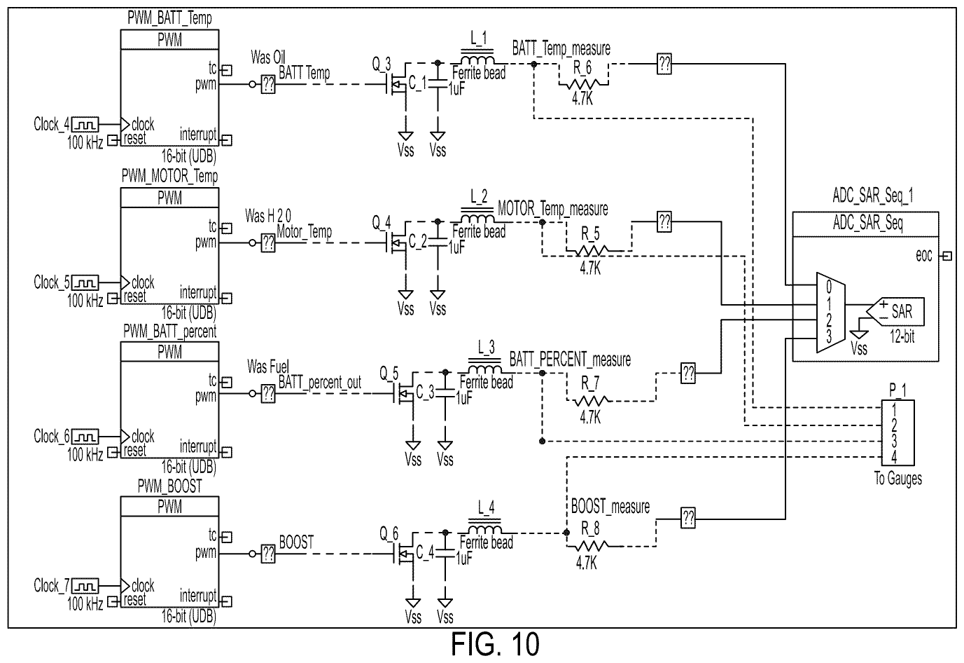

FIG. 11A is an exemplary embodiment of a portion of a wiring schematic for a system for generating a display image on one or move vehicle gauges.

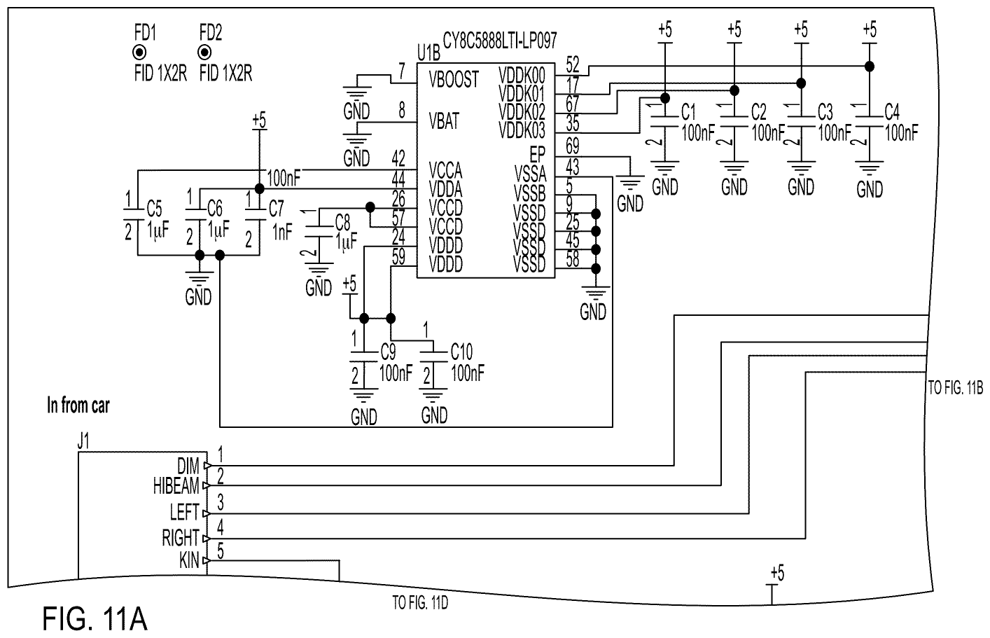

FIG. 11B is an exemplary embodiment of another portion of a wiring schematic for a system for generating a display image on one or move vehicle gauges.

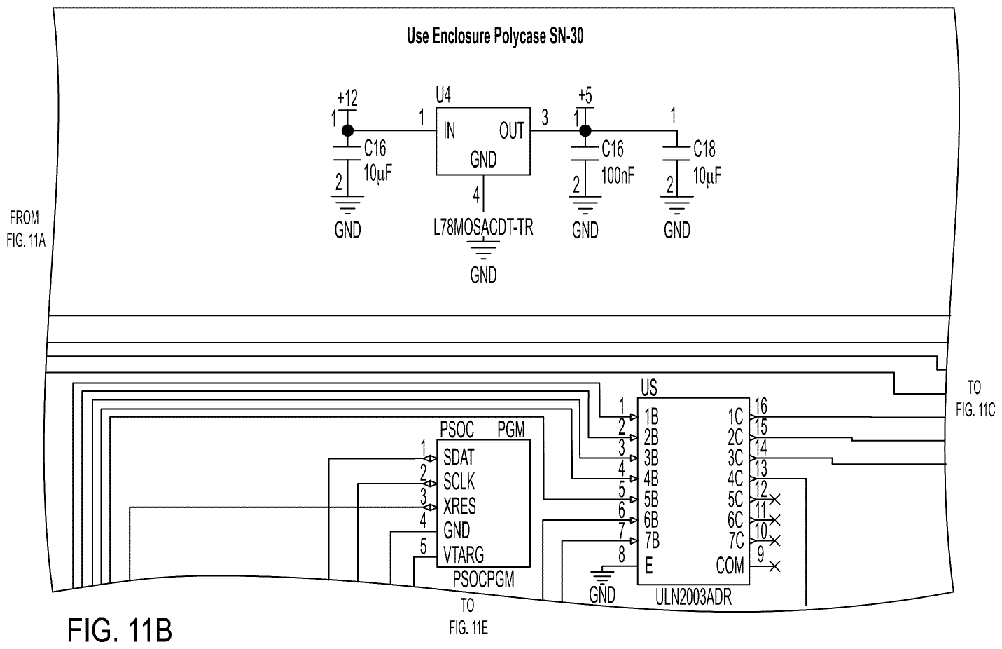

FIG. 11C is an exemplary embodiment of another portion of a wiring schematic for a system for generating a display image on one or move vehicle gauges.

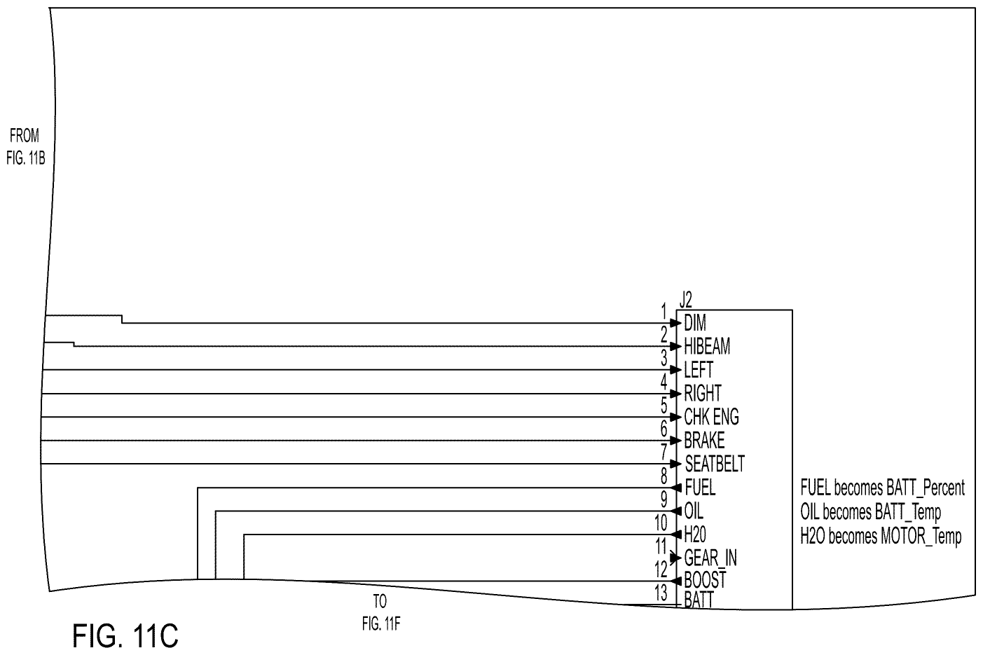

FIG. 11D is an exemplary embodiment of another portion of a wiring schematic for a system for generating a display image on one or move vehicle gauges.

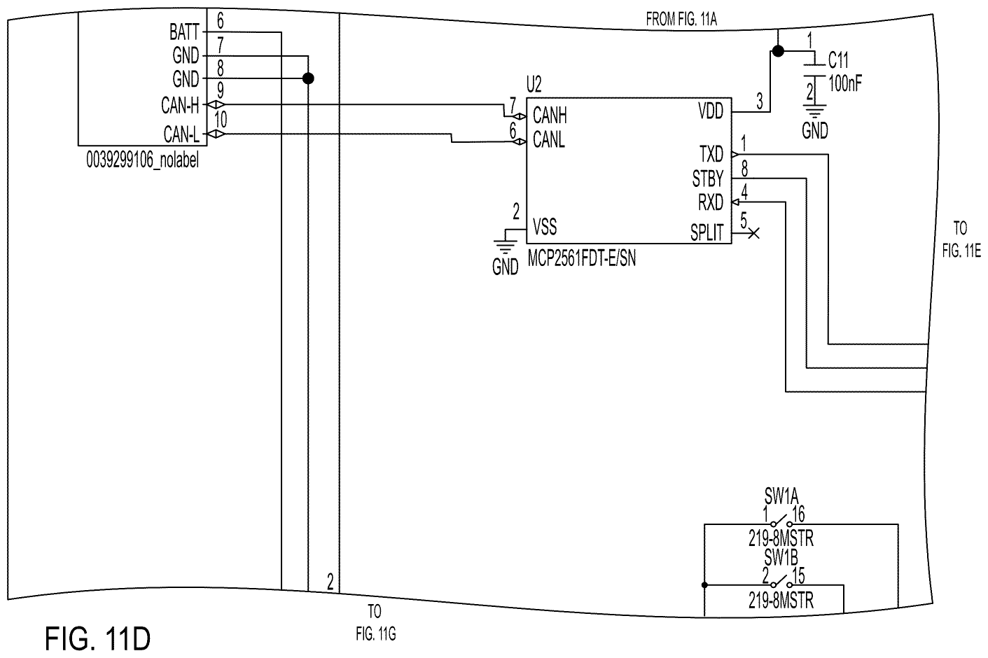

FIG. 11E is an exemplary embodiment of another portion of a wiring schematic for a system for generating a display image on one or move vehicle gauges.

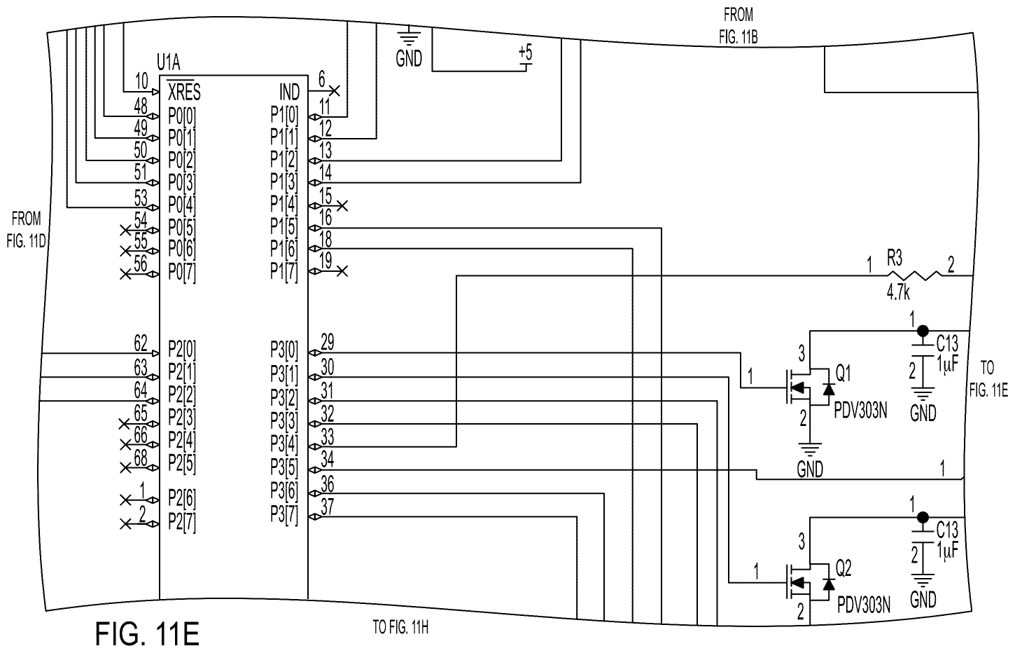

FIG. 11F is an exemplary embodiment of another portion of a wiring schematic for a system for generating a display image on one or move vehicle gauges.

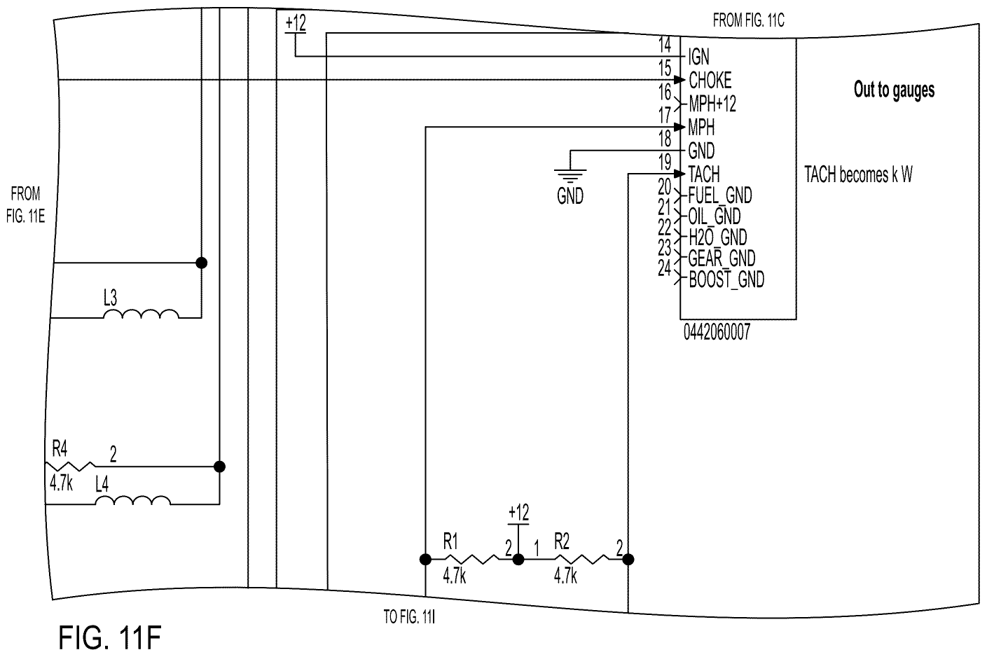

FIG. 11G is an exemplary embodiment of another portion of a wiring schematic for a system for generating a display image on one or move vehicle gauges.

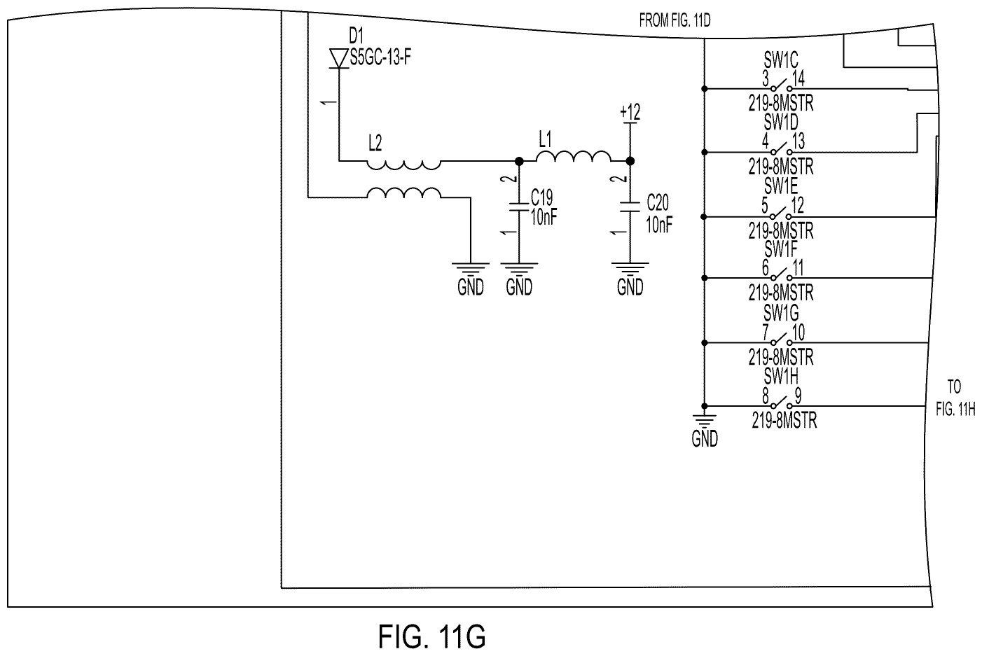

FIG. 11H is an exemplary embodiment of another portion of a wiring schematic for a system for generating a display image on one or move vehicle gauges.

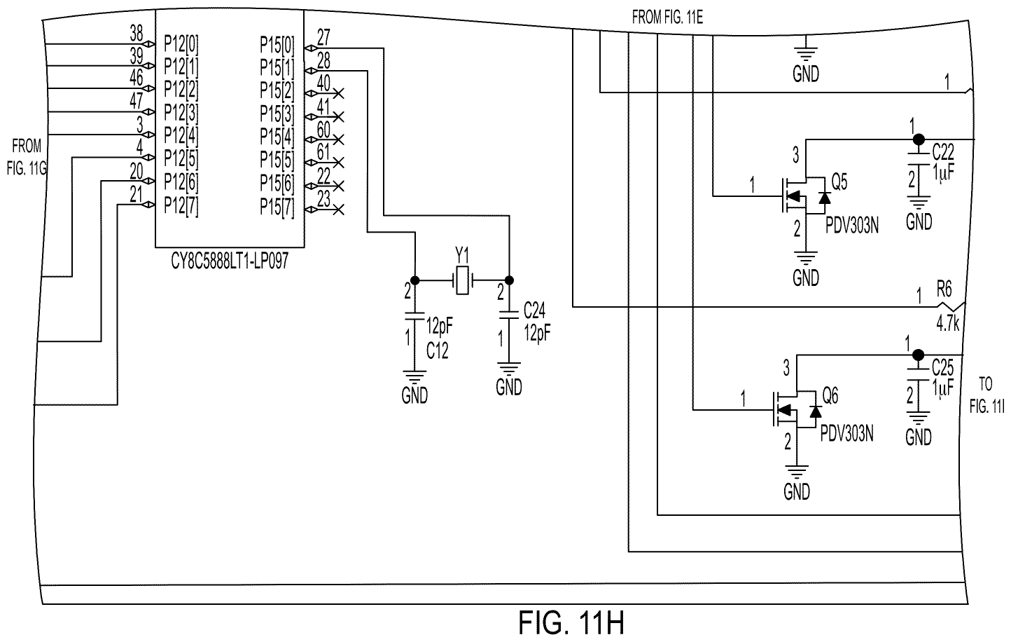

FIG. 11I is an exemplary embodiment of another portion of a wiring schematic for a system for generating a display image on one or move vehicle gauges.

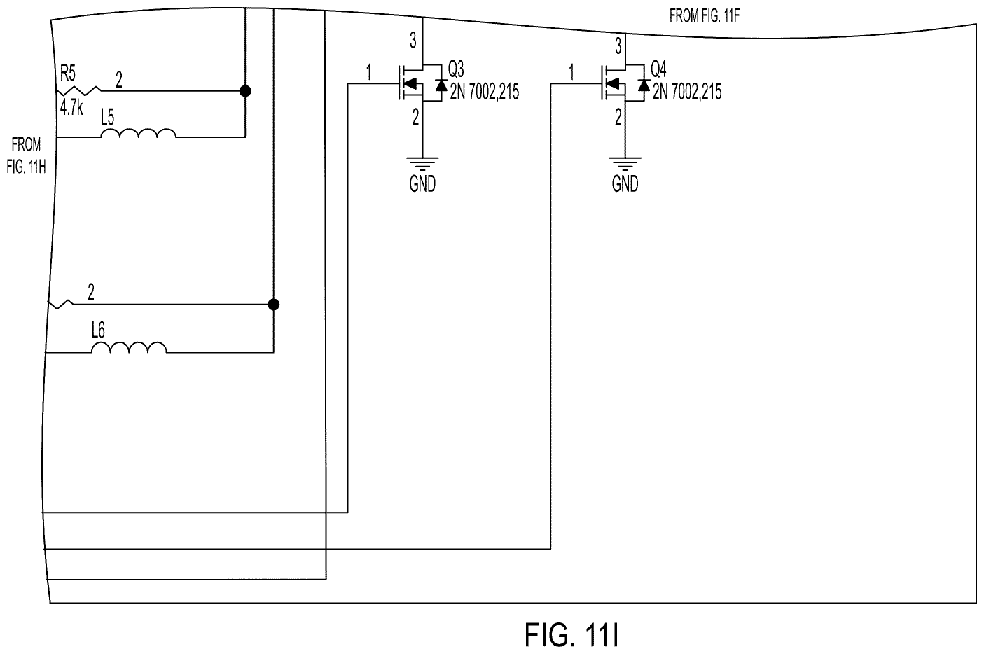

### DETAILED DESCRIPTION

Disclosed herein is a system, method, and device for converting digital data from a controller area network (CAN bus) chip to analog signals for display image on a vehicle gauge. As described herein, the following numbers refer to the following structures as noted in the Figures.
10 refers to a system.
100 refers to a converter chip.
200 refers to a controller area network (CAN bus) chip.
300 refers to a vehicle gauge.
310 refers to a speedometer.
320 refers to a battery power gauge.
330 refers to a battery state of charge gauge.
340 refers to an electric motor temperature gauge.
350 refers to a battery temperature gauge.
360 refers to a check motor gauge.

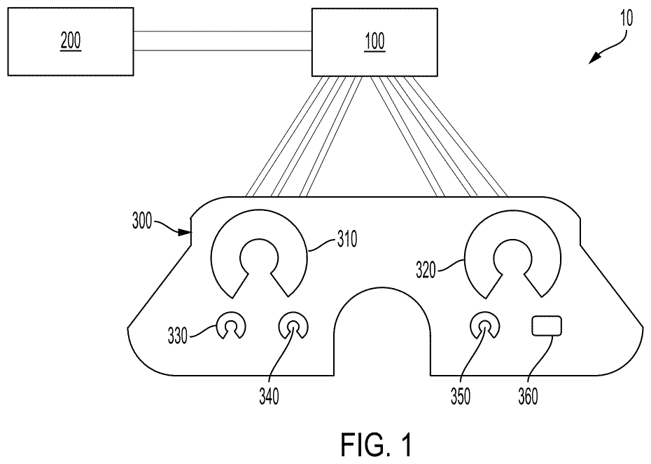

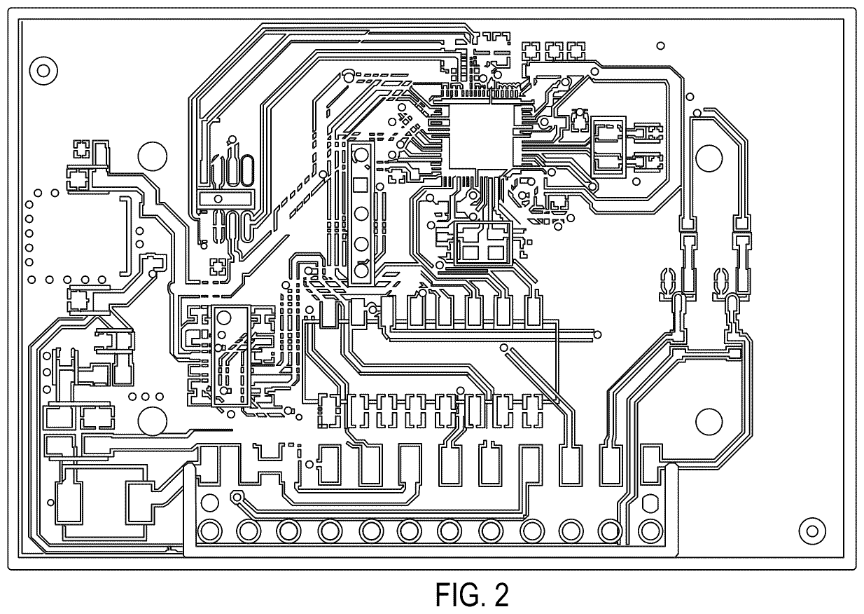

FIG. 1 is an exemplary embodiment of a system (10) for generating a display image on one or more vehicle gauges (300). The system includes a controller area network (CAN bus) chip (200), which may be an existing electric motor CAN bus chip provided as part of the electric motor and drivetrain system. The CAN bus chip is electrically connected via a first plurality of wires to a converter chip (100)—an exemplary embodiment of which is shown in FIG. 2. The first plurality of wires will include at least a first wire providing electrical power from the CAN bus chip to the converter chip, and a second wire for grounding the system.

The converter chip (100) includes a plurality of ports for electrically connecting the converter chip to the vehicle gauges (300) which may be in the form of a printed circuit board (PCB) upon which one or more individual gauges is mounted as shown in FIG. 1. Each individual gauge will be connected to the converter chip by a second plurality of wires. The second plurality of wires including at least a third wire providing electrical power from the converter chip to the gauge, and a fourth wire for grounding the system.

The plurality of vehicle gauges (300) may include any number of gauges for providing the vehicle operator with information regarding operating conditions of the vehicle. Nonlimiting examples of such gauges—shown in FIG. 1—include a speedometer (310), a battery power gauge (320), a battery state of charge gauge (330), an electric motor temperature gauge (340), a battery temperature gauge (350), and a check motor gauge (360).

The plurality of vehicle gauges (300) may include one or more analog gauges from the original internal combustion engine vehicle with the converter chip (100) including embedded software which converts the digital data from the controller area network (CAN bus) chip (200) to analog signals to operate said gauges. In doing so, it may be beneficial to change the display face of one or more of the gauges from the display face of the original internal combustion engine vehicle gauge to one which indicates the specific vehicle operation conditions of an electric motor drivetrain. For example, the existing internal combustion engine tachometer display face may be changed to a battery power display face showing the operator batter power (typically measured in kilowatts (kW)). The existing internal combustion engine fuel level gauge display face may be changed to a battery state of charge gauge display face showing the operator the percentage of battery life remaining. The existing water temperature gauge display face may be changed to an electric motor temperature gauge display face showing the operator the temperature (measured in either or both of Fahrenheit and/or Celsius) of the electric motor. The existing oil pressure gauge display face may be changed to a battery temperature gauge display face showing the operator the temperature (measured in either or both of Fahrenheit and/or Celsius) of the battery which provides electricity to the electric motor. The existing check engine display face may be changed to a check motor gauge display face.

Certain gauges such as the speedometer and the battery power gauge may be pulse driven gauges. For such gauges, an oscillator component (or “counter”) is adjusted in the embedded software to send the appropriate frequency to the analog gauge-such as the speedometer (310) and/or the battery power gauge (320) to display the appropriate vehicle operating condition information on said gauges.

Other gauges such as the battery state of charge gauge, the electric motor temperature gauge, and the battery temperature gauge may be resistance driven gauges. For such gauges, a voltage having sufficient current to overwhelm the pullup resistor is provided via the embedded software in the converter chip via a Digital to Analog Converter component connected to an amplifier allowing the converter chip to control the voltage measured by the gauge.

Alternatively, for resistance driven gauges the converter chip may include a ground connected transistor and an analog to digital converter. The embedded software in such embodiments may be configured to switch the ground connected transistor on and off by pulse width modulation, thereby drawing a current from the resistance driven gauge which simulates a variable resistance of a traditional analog sensor. The analog to digital converter verifies pulse width modulation outputs to verify the correct voltage and make corrections as needed. These corrections may be to smooth out the square wave output of the pulse width modulation by reducing rippling which may result in inaccurate outputs at the gauge. Alternatively, or in addition to, embedded software in the resistance driven gauge may be utilized to smooth out the square wave output of the pulse width modulation. In some such embodiments, the converter chip may include a capacitor and/or a ferrite bead to reduce or eliminate switching noise.

Certain other gauges may be voltage driven gauges. Such gauges may operate similarly to resistance driven gauges, but may not require the use of a pullup resistor. Instead, the gauge itself would simply measure voltage provided by the amplifier. Such gauges may be used in pulse width modulation embodiments as described herein.

The system, method, and device described herein allows existing analog gauges from an internal combustion engine vehicle to operate using digital data from a controller access network (CAN bus) chip for an electric vehicle motor and/or drivetrain. In doing so, individuals performing an EV swap on an internal combustion engine vehicle can utilize the existing analog gauges without having to supplement them with a work around such as a center-counsel mounted tablet computer and without having to sacrifice the aesthetic appeal of the original analog gauges.

While the system, method, and device have been described as having one or more exemplary designs, the present system may be further modified within the spirit and scope of this disclosure. This application is therefore intended to cover any variations, uses, or adaptations of the system, method, and device disclosed herein using their general principles.

What is claimed is:

1. A system (10) for generating a display image on one or more vehicle gauges (300) comprising:
a controller area network (CAN bus) chip (200);
a converter chip (100) comprising a plurality of ports and embedded software for converting digital data from the controller area network (CAN bus) chip to analog signals; and
one or more vehicle gauges with each vehicle gauge electrically connected to at least one port of the plurality of ports; and
wherein the controller area network (CAN bus) chip is electrically connected via a first plurality of wires to the converter chip, and the one or more vehicle gauges includes at least one vehicle gauge selected from the group consisting of a speedometer, a battery power gauge, a battery state of charge gauge, an electric motor temperature gauge, a battery temperature gauge, and a check motor gauge.

2. The system of claim 1, wherein the one or more vehicle gauges includes at least one pulse driven gauge, the controller area network (CAN bus) chip includes an oscillator component, and the embedded software is configured to adjust an electrical frequency from the oscillator component and send and adjusted frequency to the at least one pulse driven gauge.

3. The system of claim 1, wherein the one or more vehicle gauges includes at least one resistance driven gauge having a pullup resistor, the converter chip includes a digital to analog converter component connected to an amplifier, and the embedded software is configured to provide a voltage via the digital to analog converter component and amplifier to the at least one resistance driven gauge, wherein the voltage is sufficient to overwhelm the pullup resistor.

4. The system of claim 1, wherein the one or more vehicle gauges includes at least one resistance driven gauge, the converter chip includes a ground connected transistor and an analog to digital converter, and the embedded software is configured to switch the ground connected transistor on and off by pulse width modulation to send a current to the at least one resistance driven gauge.

5. The system of claim 1, wherein the one or more vehicle gauges includes at least one indicator light having a current limiting resistor electrically connected to a 12-volt power source and to ground, and the controller area network (CAN bus) chip is configured to send a signal through the converter chip to the at least one indicator light.

6. The system of claim 2, wherein the one or more vehicle gauges includes at least one resistance driven gauge having a pullup resistor, the converter chip includes a digital to analog converter component connected to an amplifier, and the embedded software is configured to provide a voltage via the digital to analog converter component and amplifier to the at least one resistance driven gauge, wherein the voltage is sufficient to overwhelm the pullup resistor.

7. The system of claim 2, wherein the one or more vehicle gauges includes at least one resistance driven gauge, the converter chip includes a ground connected transistor and an analog to digital converter, and the embedded software is configured to switch the ground connected transistor on and off by pulse width modulation to send a current to the at least one resistance driven gauge.

8. The system of claim 2, wherein the one or more vehicle gauges includes at least one indicator light having a current limiting resistor electrically connected to a 12-volt power source and to ground, and the controller area network (CAN bus) chip is configured to send a signal through the converter chip to the at least one indicator light.

9. The system of claim 3, wherein the one or more vehicle gauges includes at least one indicator light having a current limiting resistor electrically connected to a 12-volt power source and to ground, and the controller area network (CAN bus) chip is configured to send a signal through the converter chip to the at least one indicator light.

10. The system of claim 4, wherein the converter chip further comprises a capacitor.

11. The system of claim 4, wherein the one or more vehicle gauges includes at least one indicator light having a current limiting resistor electrically connected to a 12-volt power source and to ground, and the controller area network (CAN bus) chip is configured to send a signal through the converter chip to the at least one indicator light.

12. The system of claim 4, wherein the converter chip further comprises a ferrite bead.

13. The system of claim 6, wherein the one or more vehicle gauges includes at least one indicator light having a current limiting resistor electrically connected to a 12-volt power source and to ground, and the controller area network (CAN bus) chip is configured to send a signal through the converter chip to the at least one indicator light.

14. The system of claim 7, wherein the one or more vehicle gauges includes at least one indicator light having a current limiting resistor electrically connected to a 12-volt power source and to ground, and the controller area network (CAN bus) chip is configured to send a signal through the converter chip to the at least one indicator light.

15. The system of claim 7, wherein the converter chip further comprises a capacitor.

16. The system of claim 10, wherein the converter chip further comprises a ferrite bead.

17. The system of claim 15, wherein the converter chip further comprises a ferrite bead.

18. The system of claim 15, wherein the one or more vehicle gauges includes at least one indicator light having a current limiting resistor electrically connected to a 12-volt power source and to ground, and the controller area network (CAN bus) chip is configured to send a signal through the converter chip to the at least one indicator light.

19. The system of claim 16, wherein the one or more vehicle gauges includes at least one indicator light having a current limiting resistor electrically connected to a 12-volt power source and to ground, and the controller area network (CAN bus) chip is configured to send a signal through the converter chip to the at least one indicator light.

20. The system of claim 17, wherein the one or more vehicle gauges includes at least one indicator light having a current limiting resistor electrically connected to a 12-volt power source and to ground, and the controller area network (CAN bus) chip is configured to send a signal through the converter chip to the at least one indicator light.
